(19) United States
(12) Patent Application Publication
(10) Pub. No.: US 2002/0054710 A1
(43) Pub. Date: May 9, 2002

(54) Multimedia signal coding device and method of controlling amount of output code thereof

(75) Inventor: Mayumi Nagasaki, Tokyo (JP)

Correspondence Address: SUGHRUE, MION, ZINN,, MACPEAK & SEAS, PLLC, 2100 Pennsylvania Avenue, N.W., Washington, DC, 20037-3213, US

(73) Assignee: NEC CORPORATION

(21) Appl. No.: 09/985,865

(22) Filed: Nov. 6, 2001

(30) Foreign Application Priority Data
Nov. 8, 2000 (JP) 340436/2000

(51) Int. Cl. G06K 9/36

(52) U.S. Cl. 382/239

(57) ABSTRACT

Output code amount control circuit 150 confirms an accumulated amount of audio data stored in audio data buffer 111, an accumulated amount of image data stored in image data buffer 122 and an accumulated amount of control data stored in control data buffer 132 and determines a control method for controlling an amount of coded image data outputted from image coding circuit 121. Image coding circuit 121 performs a coding operation of an image signal inputted through image input terminal 120 while controlling the amount of the coded image data to be outputted, according to the control method notified by output code amount control circuit 150 and the coded image data is stored in image data buffer 120.

### BACKGROUND OF THE INVENTION

1. Field of the Invention

The present invention relates to a multimedia signal coding technology for multiplexing a plurality of signals of different kinds, including such as an audio signal, a video signal and a control data, etc., and a control method for controlling an output amount of coded data used therein.

2. Description of Related Art

A conventional multimedia signal coding device for use in a multimedia signal communication system is disclosed in, for example, JP H06-261017A. The multimedia signal coding device disclosed therein includes an audio signal CODEC and a moving picture signal CODEC and, in order to avoid a degradation of image quality of a moving picture when an amount of processing data is increased on the side of the moving picture signal CODEC, a constant amount of communicable data is maintained by controlling an output amount of coded data of the multimedia communication device such that an amount of data processing on the side of the audio signal CODEC is reduced instead of reduction of the amount of the processing data on the side of the moving picture signal CODEC by means of time-lapsing of the moving picture or change of a quantifying step.

Therefore, in the conventional multimedia signal coding device, it is necessary to control the amount of output data such that it does not exceed a data processing capacity of a multimedia signal communication system connected next to the multimedia communication signal coding device. This conventional technique will be described in more detail with reference to FIG. 5 and FIG. 6.

FIG. 5 is a block diagram showing a configuration of the conventional multimedia signal coding device. In FIG. 5, the conventional multimedia signal coding device is configured with audio input terminal 510, audio coding circuit 511, audio data buffer 512, image input terminal 520, image coding circuit 521, image data buffer 522, control data input terminal 530, control data processing circuit 531, control data buffer 532, multiplexing circuit 540, multiplexed data buffer 541, multiplexed data output terminal 542 and output coded data amount control circuit 550.

Audio coding circuit 511 performs a coding operation of an audio signal inputted through audio input terminal 510 and stores the coded audio data in audio data buffer 512. Image coding circuit 521 performs a coding operation of an image signal inputted through image input terminal 520 and stores the coded image data in image data buffer 522. Control data processing circuit 531 processes a control data inputted through control data input terminal 530 and stores the processed data in control data buffer 532. Multiplexing circuit 540 multiplexes the audio data stored in audio data buffer 512, the image data stored in image data buffer 522 and the control data stored in control data buffer 532 and stores the multiplexed data in multiplexing data buffer 541. The multiplexed data stored in multiplexed data buffer 541 is outputted externally from multiplexed data output terminal 542. Output code amount control circuit 550 confirms an amount of the image data stored in image data buffer 522, determines a control method for controlling the amount of image data outputted from image coding circuit 521 and notifies image coding circuit 521 of the thus determined control method.

A control operation for controlling the amount of the image data of the conventional multimedia signal coding device will be described with reference to a flowchart shown in FIG. 6.

In FIG. 6, output code amount control circuit 550 confirms an accumulated amount of the image data (step B1), determines the control method for controlling an amount of image data outputted from image coding circuit 521 on the basis of the confirmed amount of the accumulated image data and, then, notifies image coding circuit 521 of the thus determined control method (step B2). Image coding circuit 521, which is notified of the control method for controlling the amount of the coded image data, performs a coding operation of the image signal inputted through image input terminal 520 and, then, controls the amount of the image data to be output, according to the control method notified by output code amount control circuit 550 (step B3). Thereafter, image coding circuit 521 is stored the coded data in image data buffer 522 (step B4).

In this prior art, however, there is a problem that, since only the amount of the output data from the image coding circuit is used as the information for controlling the output code amount, it is impossible to precisely control the code amount outputted from the control information data processing circuit in real time when the output data amount of the audio coding circuit and/or the control information data processing circuit such as shown in FIG. 5 is varied.

### SUMMARY OF THE INVENTION

The present invention was made in view of the above mentioned problem of the prior art and has an object to provide a multimedia signal coding device for coding and multiplexing a plurality of signals of different kinds such as an audio signal, an image signal and a control data and transmitting the multiplexed signal, which is capable of precisely controlling an amount of coded data outputted from an image coding circuit in real time. In more detail, the object of the present invention is to provide a multimedia signal coding device capable of precisely controlling an amount of coded data outputted from an image coding circuit in real time by utilizing, as an information for controlling an amount of image data outputted from an image coding circuit, not only the amount of coded data from the image coding circuit but also an amount of coded data outputted from an audio coding circuit and a control data processing circuit. Another object of the present invention is to provide a method for controlling an output amount of coded data of the multimedia signal coding device.

According to a first aspect of the present invention, it is provided a multimedia signal coding device which comprises audio coding means for coding an input audio signal, audio data memory means for temporarily storing a coded output of the audio coding means, image coding means for coding an input image signal while controlling an amount of output data thereof according to an external control signal, image data memory means for temporarily storing a coded output of the image coding means, control data processing means for performing a predetermined data processing for an input control data, control data memory means for temporarily storing an output of the control data processing means, multiplexing means for multiplexing the data stored in the audio data memory means, the image data memory means and the control data memory means, and output code amount control means for generating a control signal for controlling an amount of output data of the image coding means on the basis of the output data amount of the multiplexing means and notifying the thus generated control signal to the image coding means.

The output code amount control means may include calculation means for calculating a total amount of the data stored in the audio data memory means, the image data memory means and the control data memory means to obtain the output data amount of the image coding means on the basis of the total amount of the data. In this case, the calculation means preferably includes determination means for obtaining a data transmission time by dividing the total amount of data by a predetermined amount of data transmission per unit time of the multimedia coding device to determine the amount of output data of the image coding means by comparing the transmission time with a requested transmission time for the multimedia signal coding device. The determination preferably includes means for decreasing the amount of image data when the transmission time is longer than the requested transmission time and increasing the amount of image data when the transmission time is shorter than the requested transmission time.

Alternatively, the multimedia signal coding device further includes multiplexed data memory means for temporarily storing the output of the multiplexing means and the output code amount control means may include means for obtaining the amount of output data of the image coding means on the basis of the amount of data stored in the multiplexed data memory means. In the latter case, the means for obtaining the amount of output data may include determination means for obtaining a data transmission time by division of the amount of data stored in the multiplexed data memory means by a predetermined amount of data transmission of the multimedia coding device and determining the amount of output data of the image coding means by comparison of the thus obtained transmission time with the requested transmission time for the multimedia signal coding device. The determination means may include means for decreasing the amount of image data when the transmission time is longer than the requested transmission time and increasing the amount of coded image data when the transmission time is shorter than the requested transmission time.

According to a second aspect of the present invention, it is provided an output code amount control method of a multimedia signal coding device for coding signals of different kinds including an audio signal, an image signal and a control data, respectively, multiplexing the coded data and then transmitting the multiplexed data, which is characterized by controlling an amount of image data obtained by coding the image signal, correspondingly to data amounts of respective kinds of codes before or after the multiplexing process.

This method comprises the step of obtaining a total amount of data of audio data obtained by coding the audio signal, image data obtained by coding the image signal and control data processed in a predetermined manner and the step of obtaining a transmission time by a division of the thus obtained amount of data by a predetermined amount of data per unit time of the multimedia coding device and controlling an amount of image data on the basis of a comparison of the transmission time with a requested transmission time for the multimedia signal coding device.

The step of controlling the amount of image data preferably comprises the step of for decreasing the amount of image data when the transmission time is longer than the requested transmission time and increasing the amount of image data when the transmission time is shorter than the requested transmission time.

### BRIEF DESCRIPTION OF THE DRAWINGS

Specific embodiments of the present invention will now be described, by way of example only, with reference to the accompanying of drawings in which:

FIG. 1 is a block diagram of a multimedia signal coding device according to a first embodiment of the present invention;

FIG. 2 is a flowchart showing a control operation of an image data amount in the multimedia signal coding device shown in FIG. 1;

FIG. 3 is a block diagram of a multimedia signal coding device according to a second embodiment of the present invention;

FIG. 4 is a flowchart showing a control operation of an image data amount in the multimedia signal coding device shown in FIG. 3;

FIG. 5 is a block diagram showing a configuration of a conventional multimedia signal coding device; and

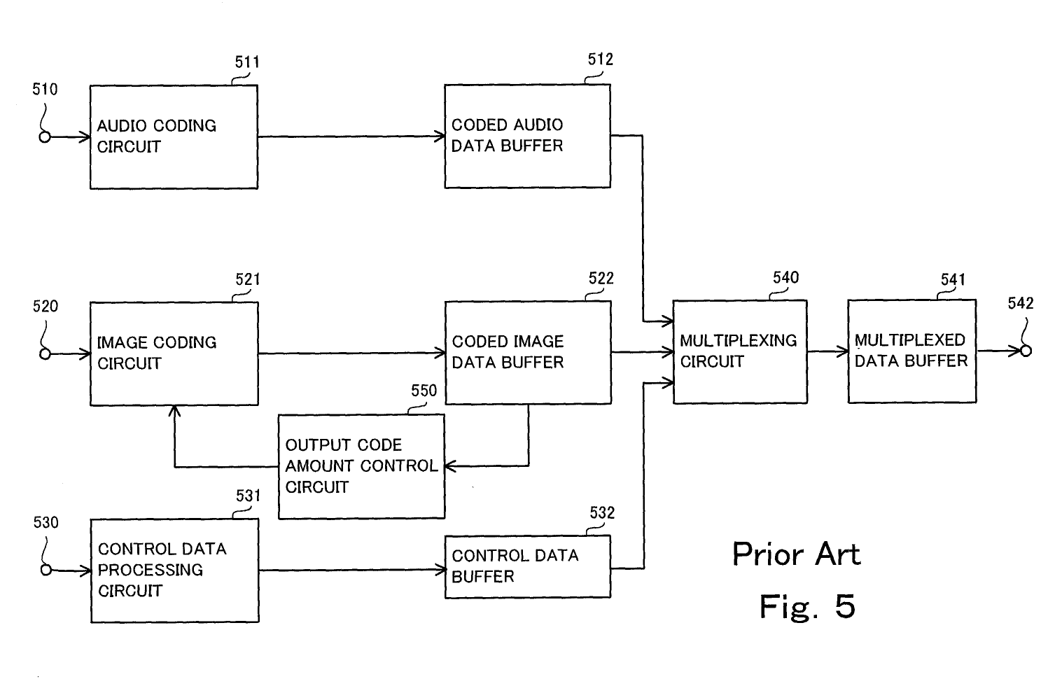

FIG. 6 is a flowchart showing a control operation of an image data amount in the conventional multimedia signal coding device shown in FIG. 5.

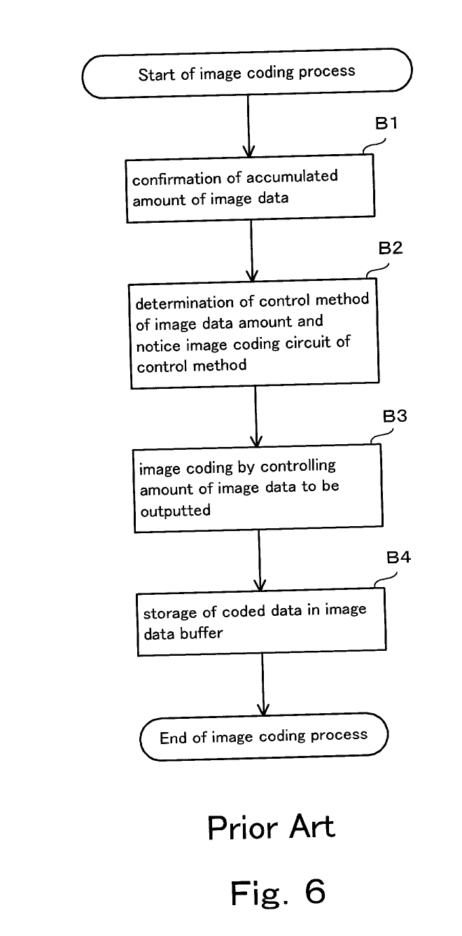

### DETAILED DESCRIPTION OF THE PREFERRED EMBODIMENTS

First Embodiment

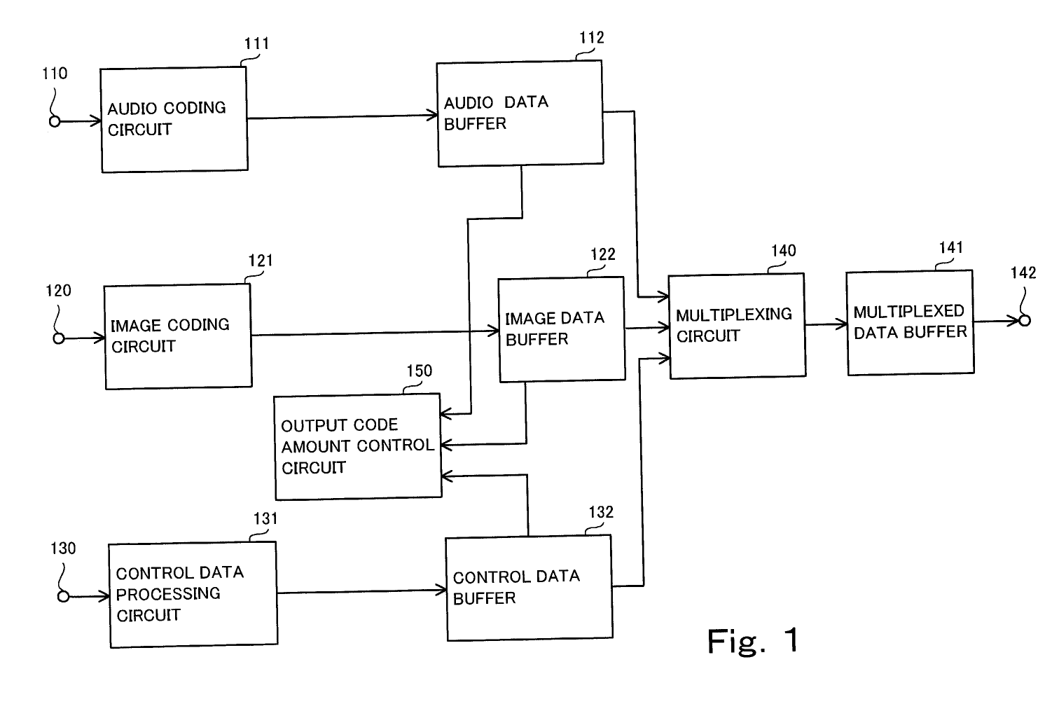

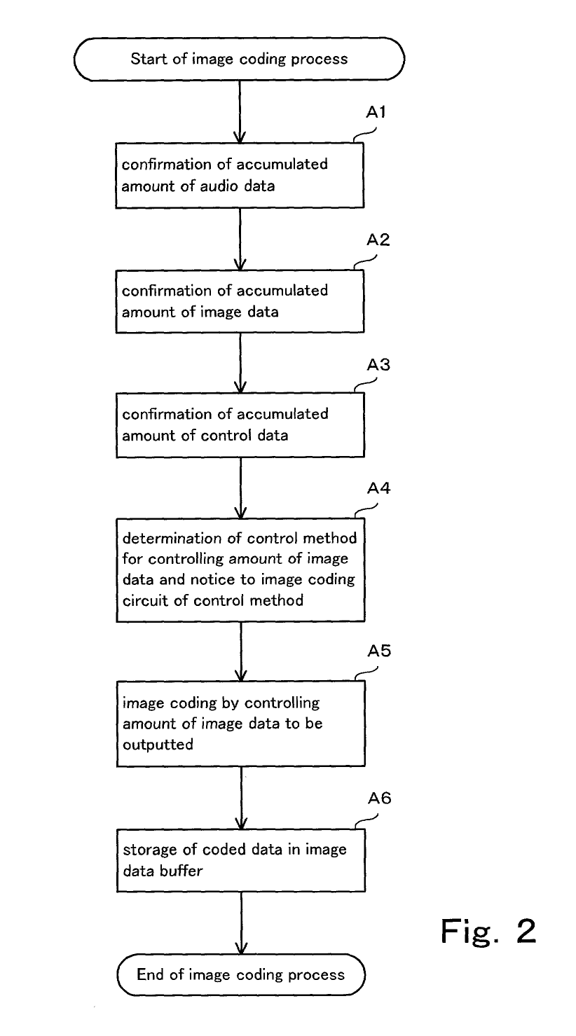

A first embodiment of the present invention will be described with reference to FIG. 1 and FIG. 2.

A multimedia signal coding device shown in FIG. 1 is configured with audio input terminal 110 inputted with an external audio signal, audio signal coding circuit 111 for quantizing the audio signal inputted through audio input terminal 110 and converting it into a digital signal value whose code amount is smaller, audio data buffer 112 for temporarily storing the audio data coded by audio coding circuit 111 and outputting the audio data according to a clock signal timely, image input terminal 120 inputted with an external image signal, image coding circuit 121 for quantizing the image signal inputted through image input terminal 120, converting it into a digital signal value whose code amount is smaller and controlling an amount of the coded output image data according to an externally supplied control method, image data buffer 122 for temporarily storing the digital image data coded by image signal coding circuit 121 and outputting the image data according to a clock signal timely, control data input terminal 130 inputted with an external control data, control information data processing circuit 131 for performing a data processing such as, for example, a protocol transformation, etc., for the control data inputted through control data input terminal 130, control data buffer 132 for temporarily storing the control data processed in control data processing circuit 131 and outputting the control data according to a clock timely, multiplexing circuit 140 for multiplexing the audio data outputted from audio data buffer 112, the image data outputted from image data buffer 122 and the control data outputted from control data buffer 132 to a single bit train, multiplexed data buffer 141 for temporarily storing the digital data multiplexed in multiplexing circuit 140 and outputting the digital data according to a clock signal timely, multiplexed data output terminal 142 for externally outputting the digital data stored in multiplexed data buffer 141, and output code amount control circuit 150 for confirming the amount of audio data accumulated in audio data buffer 112, the amount of image data accumulated in image data buffer 122 and the amount of control data accumulated in control data buffer 132, determining a control method for controlling the amount of image data outputted from image coding circuit 121 and notifying the determined control method to image coding circuit 121.

In the multimedia signal coding device constructed as mentioned above, the audio signal inputted through audio input terminal 110, which is connected to a microphone, etc., is coded by audio coding circuit 111 and stored in audio data buffer 112. Further, the image signal inputted through image input terminal 120, which is connected to a camera, etc., is coded by image coding circuit 121 while controlling the output amount of the coded image signal data according to the control method notified by output code amount control circuit 150 and stored in image data buffer 122. Further, control data processing circuit 131 performs a data processing such as protocol transformation of the control data supplied through control information input terminal 130 connected to such as a personal computer and stores the processed data in control data buffer 132.

On the other hand, output code amount control circuit 150 confirms the accumulated amount of audio data accumulated in audio data buffer 112, the accumulated amount of image data accumulated in the image data buffer 122 and the accumulated amount of control data accumulated in control data buffer 132, determines the control method for controlling the amount of image data outputted from image coding circuit 121 and notifies image coding circuit 121 of the thus determined control method.

The data stored in audio data buffer 112, image data buffer 122 and control data buffer 132 are outputted to multiplexing circuit 140 according to a clock signal timely. Multiplexing circuit 140 multiplexes the audio data, the image data and the control data to a single bit train and outputs the single bit train externally of the multimedia signal coding device through multiplexed data buffer 141 and multiplexed data output terminal 142.

As described, the multimedia signal coding device is utilized in multiplexing the audio, image and control data when a communication is performed to other terminal by transmitting/receiving the multimedia data.

Incidentally, output code amount control circuit 150 may be realized by a hardware dedicated thereto. Alternatively, output code amount control circuit 150 may be constructed with a memory and a CPU and may be realized by loading a program for realizing functions of the respective portions in the memory and executing the program.

Now, an operation of the multimedia signal coding device shown in FIG. 1 will be described with reference to FIG. 2.

In this embodiment, five operations are performed independently as mentioned above, which are as follows:

(1) First Operation

Audio coding circuit 111 performs a coding operation of the audio signal inputted through audio input terminal 110 and stores the coded audio data in audio data buffer 112.

(2) Second Operation

Image coding circuit 121 performs a coding operation of the image signal inputted through the image input terminal 120 while controlling the amount of the coded image data according to the control method notified by output code amount control circuit 150 and stores the coded image data in image coding data buffer 122.

(3) Third Operation

Control data processing circuit 131 performs the data processing of the control data inputted through control data input terminal 130 and stores the processed control data in control data buffer 132.

(4) Fourth Operation

Multiplexing circuit 140 multiplexes the coded audio data stored in audio data buffer 112, the coded image data stored in image data buffer 122 and the control data stored in control data buffer 132 and stores the multiplexed data in multiplexed data buffer 141.

(5) Fifth Operation

Multiplexed data stored in multiplexed data buffer 141 is outputted externally from multiplexed data output terminal 142.

Since the first operation and the third to fifth operations of the five operations are same as those in the prior art, the second operation of this invention will be described in detail with reference to the flowchart shown in FIG. 2.

At first, output code amount control circuit 150 confirms the accumulated amount of the audio data in audio data buffer 112′ (step Al). For simplifying the description, it will be supposed that the accumulated amount of the audio data is 100 bytes.

Next, output code amount control circuit 150 confirms the accumulated amount of the image data in image data buffer 122′ (step A2). For the same reason, it will be supposed that the accumulated amount of the image data is 500 bytes.

Next, output code amount control circuit 150 confirms the accumulated amount of the control data in control data buffer 132′ (step A3). For the same reason, it will be supposed that the accumulated amount of the image data is 0 byte

The order of steps A1, A2 and A3 can be arbitrary changed. For example, the order of step A3, step A1 and step A3 may be available.

Then, output code amount control circuit 150 sums up the confirmed amounts of the audio, image and control data, determines the control method for controlling the amount of the coded image data outputted from image coding circuit 121 and notifies the image coding circuit 121 of the control method (step A4).

For example, when the accumulated amounts of the audio, image and control data are 100 bytes, 500 bytes and 0 byte respectively, the total data amount is 100+500+0=600 bytes. This value means that the amount of data of 600 bytes is accumulated as to be outputted by the multimedia signal coding device. Assuming that a transmission rate of the multiplexed data from the multiplexed data output terminal 142 is 8000 bytes/sec, it takes 75 msec to transmit the whole data of 600 bytes.

In a case where the time of 75 msec is a value which is small compared with the data transmission time required in a system in which the present multimedia signal coding device is used, output code amount control circuit 150 determines an “increase” as the control method for controlling the amount of coded image data outputted from image coding circuit 121 and notifies the control method to image coding circuit 121.

As another example, when the accumulated amounts of the audio, image and control data are 100 bytes, 500 bytes and 7000 bytes respectively, the total data amount is 100+500+7000=7600 bytes. This value means that the amount of data of 7600 bytes is accumulated as to be outputted by the multimedia signal coding device. Assuming, in such case, that a transmission rate of the multiplexed data from the multiplexed data output terminal 142 is 8000 bytes/sec, it takes 950 msec to transmit the whole data of 7600 bytes.

In a case where the time of 950 msec is a value which is very large compared with the data transmission time required in a system in which the present multimedia signal coding device is used, output code amount control circuit 150 determines a “decrease” as the control method for controlling the amount of coded image data outputted from image coding circuit 121 and notifies the determined content of the control method to image coding circuit 121.

This operation corresponds to the control method for decreasing the amount of coded image data to be outputted from image coding circuit 121 when, for example, a large amount of control data is generated temporarily.

Image coding circuit 121 performs a coding operation of the image signal inputted through image input terminal 120 while controlling the amount of the coded image data according to the control method notified by output code amount control circuit 150 (step A5).

For example, if it is notified an “increase” from output code amount control circuit 150, image coding circuit 121 make the coded image data output increase. Practically, the amount of coded image data output can be increased by making the quantization width of image coding narrower.

If it is notified a “decrease” from output code amount control circuit 150, image coding circuit 121 make the coded image data output decrease. Practically, the amount of coded image data output can be decreased by making the quantization width of image coding wider.

Image coding circuit 121 then stores the coded image data in image coding data buffer 122 (step A6).

Second Embodiment

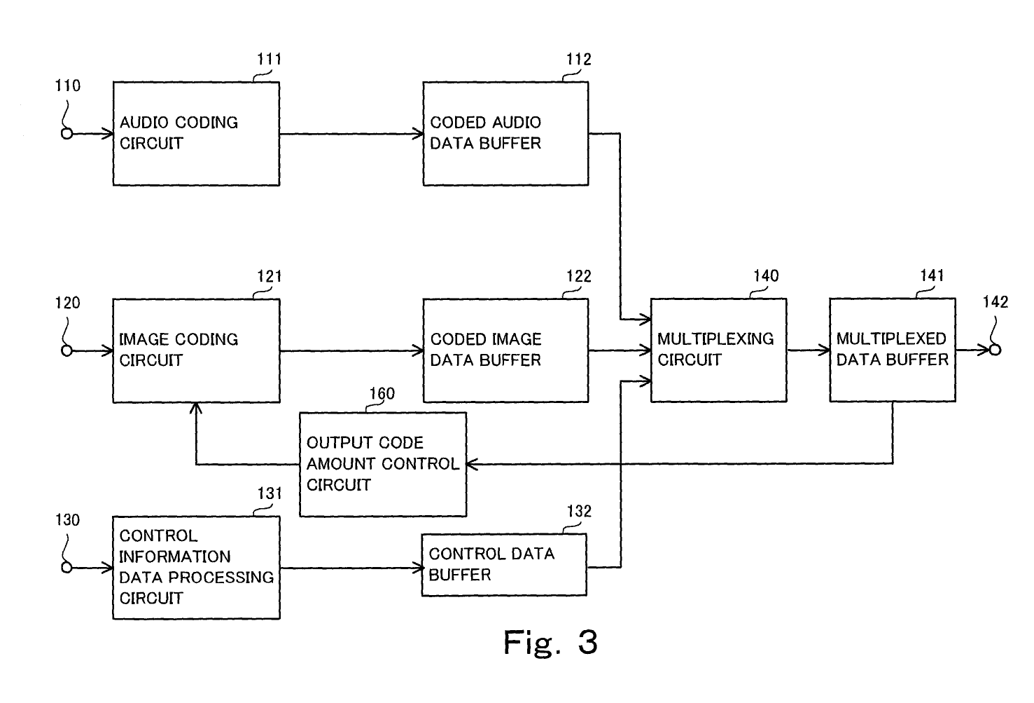

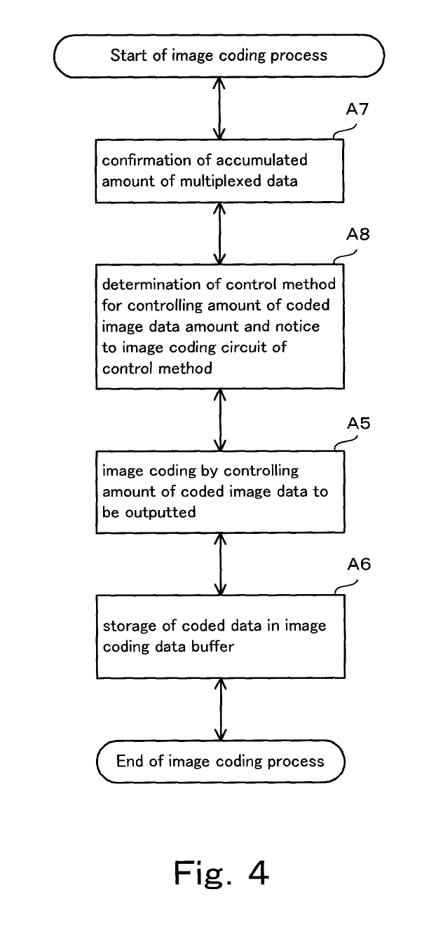

A second embodiment of the present invention will be described with reference to FIG. 3 and FIG. 4.

FIG. 3 is a block diagram of a multimedia signal coding device according to the present embodiment.

Since elements indicated by the same numerals as those of the first embodiment perform same operations as those of the first embodiment, description for that blocks will be omitted.

The element indicated by a different numeral from the first embodiment is output code amount control circuit 160 which confirms the amount of multiplexed data accumulated in multiplexed data buffer 141, determines a control method for controlling the amount of image data outputted from image coding circuit 121 and notifies the determined control method to image coding circuit 121.

Now, an operation of the second embodiment will be described with reference to FIG. 4. It will be described only an operation corresponding to the “second operation” described in the first embodiment.

At first, output code amount control circuit 160 confirms the accumulated amount of the audio data in multiplexed data buffer 141 (step A7).

According to the accumulated amount of the multiplexed data thus confirmed, output code amount control circuit 160 determines the control method for controlling the amount of coded image data outputted from image coding circuit 121 and notifies the control method to image coding circuit 121 (step A8).

For example, when the accumulated amount of the multiplexed data is 600 bytes, this value means that the amount of data of 600 bytes is accumulated as to be outputted by the multimedia signal coding device. Assuming that a transmission rate of the multiplexed data from multiplexed data output terminal 142 is 8000 bytes/sec, it takes 75 msec to transmit the whole data of 600 bytes.

In a case where the time of 75 msec is a value which is small compared with the data transmission time required in a system in which the present multimedia signal coding device is used, output code amount control circuit 160 determines an “increase” as the control method for controlling the amount of coded image data outputted from image coding circuit 121 and notifies the control method to image coding circuit 121.

As another example, assuming that the accumulated amount of the multiplexed data is 7600 bytes, this value means that the amount of data of 7600 bytes is accumulated as to be outputted by the multimedia signal coding device. Assuming, in such case, that a transmission rate of the multiplexed data from multiplexed data output terminal 142 is 8000 bytes/sec, it takes 950 msec to transmit the whole data of 7600 bytes.

In a case where the time of 950 msec is a value which is very large compared with the data transmission time required in a system in which the present multimedia signal coding device is used, output code amount control circuit 150 determines a “decrease” as the control method for controlling the amount of coded image data outputted from image coding circuit 121 and notifies the determined content of the control method to image coding circuit 121.

This operation corresponds to the control method for decreasing the amount of coded image data to be outputted from image coding circuit 121 when, for example, a large amount of control data is generated temporarily.

Since the control method of the image signal coding operation in image coding circuit 121 and the operation of the multimedia signal coding device subsequent to the operation of image coding circuit 121 are the same as those described with first embodiment, the description of them is omitted.

Incidentally, the output code amount control circuit of the above mentioned multimedia signal coding device may be realized by recording a program for realizing the function thereof in a computer readable recording a medium and executing the program by reading it by means of a computer system.

The term “computer system” in this description includes an OS and a hardware of such as peripheral equipment and, when the computer system is utilizing WWW (World Wide Web) system, it includes a home page providing environment (or display environment). The term “computer readable recording medium” means a portable memory device such as floppy disk, magneto optical disk, ROM or CD-ROM, etc., or a hard disk, etc., housed in the computer system. Further, the computer readable recording medium may include means such as transmission medium or transmission wave for dynamically holding a program for a short time period in such case as when a program is transmitted by using a computer network of such as an internet, etc., or a communication line such as telephone line, or means such as volatile memory within a computer system, which becomes a server or a client in the same case, for holding a program for a constant time.

The above mentioned program may be one for realizing a portion of the previously mentioned function or may be the so-called differential file or differential program, which can be realized by combining the function with a program already stored in a computer system.

As described hereinbefore, in the multimedia signal coding device according to the present invention, which is used to multiplex an audio signal, an image signal and control data, which are coded, to form a multimedia data and communicate with the other by transmitting/receiving the same, not only the amount of data outputted from the image coding circuit but also the amount of output data of the audio coding circuit and the control data processing circuit are used as information for controlling the amount of the coded image data outputted from the image coding circuit. Therefore, even when the amount of data outputted from the audio coding circuit and/or the amount of data outputted from the control data processing circuit is varied, it is possible to precisely control the amount of coded data outputted from the image coding circuit in real time.

What is claimed is:

1. A multimedia signal coding comprising:
audio signal coding means for coding an input audio signal;
audio data memory means for temporarily storing a coded output of said audio signal coding means;
image signal coding means for coding an input image signal while controlling an amount of output data according to an external control signal
coded image data memory means for temporarily storing a coded output of said image signal coding means;
control data processing means for performing a predetermined data processing for an input control data;
control data memory means for temporarily storing an output of said control data processing means;
multiplexing means for multiplexing the data stored in said audio data memory means, said image data memory means and said control data memory means; and
output code amount control means for generating a control signal for controlling an amount of output data of said image coding means on the basis of the output data amount of said multiplexing means and notifying the generated control signal to said image signal coding means.

2. A multimedia signal coding device as claimed in claim 1, wherein said output code amount control means includes calculation means for calculating a total amount of the data stored in said audio data memory means, said image data memory means and said control data memory means to obtain the amount of output data of said image signal coding means on the basis of the total amount of the data.

3. A multimedia signal coding device as claimed in claim 2, wherein said calculation means includes determination means for obtaining a data transmission time by dividing the total data amount by a predetermined amount of data transmission per unit time of said multimedia coding device and determining the amount of output data of said image signal coding means by comparing the transmission time with a requested transmission time requested for said multimedia signal coding device.

4. A multimedia signal coding device as claimed in claim 3, wherein said determination means includes means for decreasing the amount of coded image signal data when the transmission time is longer than the requested transmission time and increasing the amount of coded image signal data when the transmission time is shorter than the requested transmission time.

5. A multimedia signal coding device as claimed in claim 1, further comprising multiplexed data memory means for temporarily storing the output of said multiplexing means, wherein said output code amount control means includes means for obtaining the amount of the output data of said image signal coding means on the basis of the amount of data stored in said multiplexed data memory means.

6. A multimedia signal coding device as claimed in claim 5, wherein said means for obtaining the amount of output data includes determination means for obtaining a data transmission time by division of the amount of data stored in said multiplexed data memory means by a predetermined data transmission amount of said multimedia coding device and determining the amount of output data of said image signal coding means by comparison of the thus obtained transmission time with the requested transmission time requested for said multimedia signal coding device.

7. A multimedia signal coding device as claimed in claim 6, wherein said determination means includes means for decreasing the amount of coded image data when the transmission time is longer than the requested transmission time and increasing the amount of coded image data when the transmission time is shorter than the requested transmission time.

8. An output code amount control method of a multimedia signal coding device for coding signals of different kinds including an audio signal, an image signal and a control data, respectively, multiplexing the coded data and then transmitting the multiplexed data, comprising the step of controlling an amount of image data obtained by coding the image signal, correspondingly to data amounts of respective kinds of codes before or after the multiplexing process.

9. An output code amount control method as claimed in claim 8, comprising the steps of:
obtaining a total amount of data of audio data obtained by coding the audio signal, image data obtained by coding the image signal and control data processed in a predetermined manner; and
obtaining a transmission time by a division of the thus obtained data amount by a predetermined data amount per unit time of the multimedia coding device and controlling an amount of image data on the basis of a comparison of the transmission time with a request transmission time requested for the multimedia signal coding device.

10. An output code amount control method as claimed in claim 9, wherein the step of controlling the amount of coded image data comprises the step of decreasing the amount of coded image data when the transmission time is longer than the requested transmission time and increasing the amount of coded image data when the transmission time is shorter than the requested transmission time.

11. A computer readable recording medium having said output code amount control method as claimed in any of claims 8 to 10 recorded as a program for executing said output code amount control method by a computer.
